(19) United States
(12) Patent Application Publication
(10) Pub. No.: US 2018/0001777 A1
(43) Pub. Date: Jan. 4, 2018

(54) CHARGING STATION AND METHOD FOR AUTOMATICALLY CHARGING AN ELECTRICAL ENERGY STORAGE MEANS IN A VEHICLE

(71) Applicant: Robert Bosch GmbH, Stuttgart (DE)

(72) Inventor: Ahmet Kilic, Boeblingen (DE)

(21) Appl. No.: 15/537,559

(22) PCT Filed: Oct. 19, 2015
(86) PCT No.: PCT/EP2015/074104

§ 371 Date: Jun. 19, 2017

(30) Foreign Application Priority Data
Dec. 18, 2014 (DE) 102014226357.3

(51) Int. Cl. B60L 11/18

(52) U.S. Cl. CPC B60L 11/1835; B60L 11/1848; B60L 11/1846; B60L 11/1816; B60L 2230/16; B60L 2230/40

(57) ABSTRACT

The invention relates to a device and a method for automatically charging an electrical energy storage means in a vehicle. For this purpose, firstly, the position of a charging socket on a vehicle is determined, based on vehicle-specific data. Subsequently, a charging robot travels on the ground near to the charging socket. Then, the charging robot establishes a galvanic connection between the charging station and charging socket. For this purpose, the charging robot introduces a contact head connected to the charging station into the charging socket of the vehicle. After termination of the charging process, the contact head is removed from the charging socket, thereby releasing the vehicle.

### BACKGROUND OF THE INVENTION

The present invention relates to a charging station and a method for automatically charging an electrical energy storage means in a vehicle.

The publication DE 10 2009 001 080 A1 discloses a charging device for a land-based motor vehicle including a battery-like power storage device. An electrical connection between the power storage device and a charging device may be established via a contact arm. The contact arm is movably attached to the charging device.

Inductive and conductive charging methods are known for charging the traction batteries in electric or hybrid vehicles. The inductive charging methods are based on a combination of a transmitting coil and a receiving coil system. In contrast, conductive charging methods require the insertion of a charging cable between a charging station and the electric or hybrid vehicle. The convenience of charging the electrical energy storage means will play a decisive role in the acceptance of future electric or hybrid vehicles.

Therefore, there is a need for a charging station and a method for automatically charging an electrical energy storage means in a vehicle, in particular an electric or hybrid vehicle, which enables convenient, reliable, and efficient charging of the electrical energy storage means.

### SUMMARY OF THE INVENTION

For this purpose, according to a first aspect, the present invention provides a charging station for automatically charging an electrical energy storage means in a vehicle. The charging station includes a communication device which is designed to receive vehicle-specific data from the vehicle and to ascertain a position of a charging socket on the vehicle using the received vehicle-specific data. The charging station furthermore includes a charging robot which includes a contact head having a plurality of contacts. The contacts are connected to a voltage source. The charging robot is designed to travel to a charging position based on the ascertained position of the charging socket on the vehicle, and after reaching the charging position, to insert the contact head into the charging socket of the vehicle and to electrically connect the contacts of the contact head to contacts of the charging socket.

According to an additional aspect, the present invention provides a method for automatically charging an electrical energy storage means in a vehicle. The method includes the steps of providing a charging robot which includes a contact head having a plurality of contacts, wherein the contacts are connected to a voltage source; receiving vehicle-specific data from the vehicle; ascertaining the position of a charging socket on the vehicle using the received vehicle-specific data; determining a charging position based on the ascertained position of the charging socket on the vehicle; traveling to the charging position by means of the charging robot; inserting the contact head of the charging robot into the charging socket of the vehicle; and electrically connecting the contacts of the contact head to contacts of the charging socket after the charging robot has reached the charging position.

Conductive charging methods enable a relatively low-loss transmission of large amounts of energy. The present invention is based on the knowledge that the position of the charging sockets on vehicles may vary. Thus, for example, depending on the design, different positions of the charging sockets may be advantageous for different vehicle types. In addition, generally, it is not possible, or it is hardly possible, for a vehicle driver to position a vehicle exactly at a predefined position at a charging station. In addition to other factors, automatically connecting a charging cable to the charging socket of an electric or hybrid vehicle is thereby made more difficult.

The idea underlying the present invention is therefore to take this knowledge into account and to provide a charging station and a method for charging an energy storage means in a vehicle which enable a flexible and reliable electrical connection of the charging socket of a vehicle to a voltage source. By transmitting vehicle-specific data about the vehicle to be charged to the charging station, the charging station is able to individually ascertain the exact spatial position of the charging socket of the respective vehicle, for different vehicles. If the vehicle-specific data, for example, also include a spatial position of the vehicle to be charged with respect to the charging station, it is also possible to take into account and compensate for variations when parking the vehicle to be charged. An exact spatial position of the vehicle and optional related additional assistance systems are therefore not required.

Since the determination of the position of a charging socket on the vehicle is carried out based on vehicle-specific data transmitted by the vehicle, no additional sensors are required to detect the position of the charging socket on the vehicle. Therefore, it is possible to automatically connect the charging socket of an electric or hybrid vehicle to a charging station in a reliable and economical manner.

The flexibility in determining the position of the charging socket and the subsequent automatic positioning of a charging robot at a suitable position for connecting the vehicle allows high flexibility for different vehicle types. In particular, charging sockets may be serviced by a common charging station at different positions of the vehicle, for example, the front, rear, side portions, or underbody. Charging sockets at different heights may also be detected and connected. Thus, vehicles having different ground clearances, for example, sports cars or sports utility vehicles (SUVs), may be serviced by a common charging station.

In addition, the high flexibility of the charging robot also allows the simultaneous or sequential servicing of multiple adjacent vehicles. Thus, for example, by means of a charging station including a charging robot, multiple vehicles which are parked adjacently may be automatically connected and charged in succession without requiring manual user intervention. In this way, it is possible to charge multiple electric or hybrid vehicles using only one charging station, without having to move the vehicles to a different parking space for charging. Therefore, a separate charging station is not required for each individual parked vehicle. Thus, the costs for the infrastructure for charging electric vehicles may also be reduced.

According to one embodiment, the contact head of the charging robot includes funnel-shaped or groove-shaped recesses. Contacts of the contact head are arranged in these funnel-shaped or groove-shaped recesses. By arranging the contacts in recesses, the contacts may be protected from inadvertent contact, for example, by a person. Adequate protection from live contacts is thereby ensured. In addition, the funnel-shaped or groove-shaped configuration of the recesses enables simple, reliable insertion of the contact head into the charging socket of the vehicle. Funnel-shaped or groove-shaped (V-shaped) recesses allow the contact head to be adjusted independently within a tolerance range during insertion into the charging socket, so that reliable automatic connection is still possible even in the case of inexact positioning of the charging robot.

According to one embodiment, the contact head includes a guiding device. The guiding device is designed to adjust the position of the contact head during insertion into the charging socket. Preferably, the guiding device may comprise a roller, a ball wheel, a peg, a groove, and/or a slide rail. By means of such a guiding device, the fine adjustment may be further improved during insertion of the contact head into the charging socket. The requirements for accuracy when positioning the charging robot are therefore reduced. This allows for simpler and more economical control of the charging robot.

According to an additional embodiment, the contact head has a conical exterior geometry. In this case, the diameter of the contact head tapers in the direction of the contacts. In this context, “conical” is to be understood to mean the geometry of a surface of revolution which results from a curve rotating about an axis. In this case, the axis of rotation may preferably at least approximately coincide with a direction in which the contact head moves during the connection process. If such a conical contact head is introduced into a preferably funnel-shaped charging socket, a reliable automatic adjustment of the contact head may take place during the connection.

According to an additional embodiment, the charging robot includes a rotating device which is designed to rotate the contact head about a predetermined axis of rotation. Preferably, this axis of rotation coincides exactly or at least approximately with a direction of movement in which the contact head is moved in the direction of the charging socket for connecting to the charging socket. By means of the rotation, i.e., the rotation of the contact head, the contact head may be oriented with respect to the contacts of the charging socket. Thus, the contact head may also be optimally oriented in the case of an arrangement of contacts which is not rotationally symmetrical.

According to another embodiment, the charging robot includes a surroundings sensor which is designed to detect an object in the surroundings of the charging robot. Preferably, the surroundings sensor includes a camera, an ultrasonic sensor, a laser detector (LiDAR), a radar sensor, and/or a contact sensor. By means of such a sensor system, it is possible for the charging robot to automatically head for its position for connecting the contact head to the charging socket without colliding with an obstacle. Furthermore, the sensor system may also be used to determine the exact position of the charging socket on the vehicle to be charged.

According to another embodiment, the communication device includes a radio interface, for example, a WLAN, NFC, GSM; an infrared interface; a camera; a barcode scanner; and/or a QR code scanner. By means of such a communication device, the vehicle-specific data may be transmitted from the vehicle to the charging station in a non-contact manner and without additional interactions by a user.

According to one embodiment, the step for ascertaining the position of the charging socket on the vehicle involves reading the position of the charging socket using the received vehicle-specific data from an internal and/or external database. In this case, a link is also possible in the respective database to additional data which is relevant to charging the vehicle. In this way, a simple and efficient ascertainment of the position of the charging socket on the vehicle may be made possible.

According to one embodiment, the method for automatically charging the energy storage means in a vehicle includes a step for ascertaining charging parameters for charging the electrical energy storage means in the vehicle, using the received vehicle-specific data. In this case, the vehicle-specific data may, for example, include a charging voltage, a charging current, an amount of energy to be transmitted, a start time for charging the energy storage means, an end time for charging the energy storage means, a time period for charging the energy storage means, and/or billing data. In this way, a set of charging parameters may be determined individually for each vehicle to be charged, so that the energy storage means of the vehicle may be charged in the best possible manner.

Additional embodiments and advantages of the present invention result from the following description with reference to the appended drawings.

### BRIEF DESCRIPTION OF THE DRAWINGS

The following are shown:

FIG. 1: a schematic representation of a charging station according to one embodiment;

FIGS. 2a to 2d: schematic representations of a contact head of a charging robot in a charging station according to additional embodiments;

FIG. 3: a schematic representation of the interaction of a contact head with the charging socket of a vehicle according to another embodiment;

FIG. 4: a schematic representation of the interaction of a contact head with a charging socket of a vehicle according to yet another embodiment;

FIGS. 5a, 5b: schematic representations of the interaction of a contact head and a charging socket according to additional embodiments;

FIGS. 6a to 6d: a schematic representation of the charging of a vehicle based on one embodiment;

FIG. 7: a schematic representation of a charging station according to one embodiment for charging multiple vehicles; and

FIG. 8: a schematic representation of a flow chart as based on a method according to another embodiment.

### DETAILED DESCRIPTION

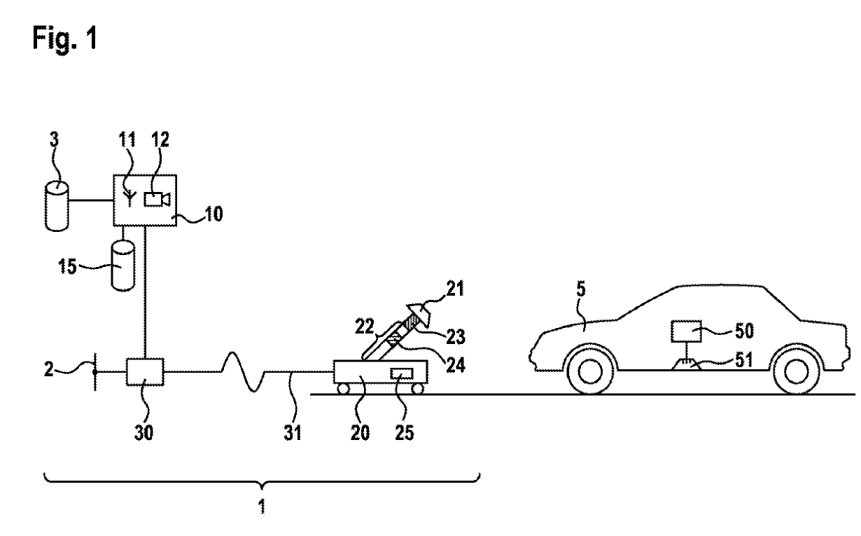

FIG. 1 shows a schematic representation of a charging station 1 for automatically charging an energy storage means 50 in a vehicle 5. The vehicle 5 may, for example, be a hybrid or electric vehicle. In particular, the vehicle 5 may be a motor vehicle such as a passenger car or a truck which is entirely or partially electrically driven. The charging station 1 includes at least one communication device 10 and one charging robot 20. The communication device 10 may receive vehicle-specific data from the vehicle 5 to be charged. The data transmission is carried out at least from the vehicle 5 in the direction of the communication device 10. Alternatively, bidirectional data transmission between the vehicle 5 and the communication device 10 is also possible. The communication device 10 may, for example, include a radio interface 11. A wireless data exchange between the communication device 10 and the vehicle 5 is possible by means of this radio interface 11. For example, the radio interface 11 may establish a WLAN connection with the vehicle 5. Alternatively, a connection via a mobile telephone network, for example, GSM, UMTS, or LTE, is also possible. Furthermore, a wireless data exchange may also be carried out by means of near-field communication (RFID/NFC). In addition, other wireless communication methods are also possible. In addition or alternatively, the communication device 10 may also include an optical sensor 12 or an optical interface. For example, the optical sensor 12 may be a camera, a barcode scanner, or a QR code scanner. Thus, for example, a camera may optically detect the vehicle 5 to be charged. Based on predetermined features in an image of the vehicle 5 detected by the camera, vehicle-specific data may be ascertained about the vehicle 5 to be charged. In addition, a barcode, a QR code, or another optical code which is attached to the vehicle 5 to be charged, may also be detected and read out via a suitable scanner. Furthermore, for example, an optical interface, for example, an infrared interface, is also possible, by means of which vehicle-specific data may be exchanged between the vehicle 5 to be charged and the communication device 10.

The vehicle-specific data may, for example, be data which specify the position of a charging socket 51 on the vehicle 5 to be charged. These data for specifying the position of the charging socket 51 on the vehicle 5 may, for example, specify whether the charging socket 51 is present on the underbody, on the front, the rear, or on the side of the vehicle 5. In addition, these data may also specify the exact position of the charging socket 51. For example, the position of a charging socket 51 relative to a Cartesian coordinate system with a predefined reference point on the vehicle may be specified as the origin of the coordinate system. In addition, other data formats are also possible for specifying the charging socket 51 on the vehicle 5. In addition, the vehicle-specific data may also include other data, in particular data which are relevant to charging the vehicle 5. Thus, the vehicle-specific data may, for example, also contain data about the required charging voltage (voltage level, voltage type: DC voltage or single- or multiphase AC voltage), maximum possible charging current, required amount of energy to be transmitted, information about the energy storage means 50 to be charged in the vehicle 5, and authorization data or billing data. In addition, the transmission of other vehicle-specific data, in particular of data which are relevant to charging the energy storage means 50 in the vehicle 5, is possible.

In addition to the above-described option, in which the position of the charging socket 51 on the vehicle 5 to be charged, and possibly required additional data relevant to the charging, are transmitted directly to the communication device 10 by means of the vehicle-specific data transmitted from the vehicle 5, it is also possible to transmit only a vehicle-specific identification (ID) from the vehicle 5 to the communication device 10. This vehicle-specific identification may, for example, be a separate, unambiguous identification for each individual vehicle 5. Alternatively, the identification transmitted in the vehicle-specific data may also be an identification which specifies only the type of a vehicle. In the latter case, identical vehicles may transmit a common identification to the communication device 10. On the basis of such an identification included in the vehicle-specific data, which is transmitted from the vehicle 5 to the communication device 10, the communication device 10 may subsequently ascertain the data relevant to the charging process. For example, for this purpose, the charging station 1 may contain an internal database 15. The relationships between the vehicle-specific data and the information which is relevant to the charging of a vehicle 5 may be stored in this internal database 15. In this case, the communication device 10 may access the internal database 15 and thus read out all information relevant to the charging of the vehicle 5, based on the received vehicle-specific data. Alternatively or in addition, the communication device 15 may also be linked to an external database 3. For example, the external database 3 may be a central database which multiple communication devices 10 may access from multiple charging stations 1. Thus, it is necessary only to keep the data up-to-date in one or a few central databases 3, without having to transmit an update to all charging stations 1 for each change.

For example, the license number of a vehicle may also be detected via the optical sensor 12, for example, in the form of a camera. Using the detected license number of the vehicle 5 to be charged, the data which are relevant to charging the vehicle 5 may subsequently be determined from the internal database 15 or the external database 3.

Using the vehicle-specific data received by the communication device 10, the charging station 1 determines all charging parameters which are relevant to charging the energy storage means 50 in the vehicle 5, for example, in the communication device 10 or another device. These charging parameters may, for example, include the following parameters: position of the charging socket 51 on the vehicle 5 to be charged, possible or required voltage for charging the energy storage means 50 (in particular, voltage level, voltage type: DC voltage, single-phase or multiphase AC voltage), maximum permissible amperage, required amount of energy to be transmitted, time at which charging is to be started, time at which charging is to be concluded, time period for charging the energy storage means 50, configuration of the charging socket 51 on the vehicle 5, authorization parameters, billing data, etc. In addition, other parameters not listed here, which may be relevant to, or of interest for, charging the energy storage means 50 in the vehicle 5, are also possible.

For charging the energy storage means 50 in the vehicle 5, it may be necessary for the vehicle 5 to be parked as precisely as possible in a predefined position or in one of multiple predefined positions. For this purpose, the charging station 1 may, for example, have a parking lot or another parking area for one or multiple vehicles 5, which has predetermined aids for positioning the vehicle 5 in its parking area. For example, these aids may be visual markings which specify the position of the vehicle 5 to be charged. In addition, uneven surfaces, for example, elevations or depressions in the parking area, are also possible, which assist the driver in positioning the vehicle 5 as precisely as possible in the parking lot. In addition, automated positioning of the vehicle, for example, by means of a driver assistance system, is also possible. After transmitting the vehicle-specific data to the charging station and transmitting the position of the charging socket on the vehicle which is known as a result, the precise position of the charging socket 51 with respect to the charging station 1 is also known, due to the positioning of the vehicle 5 as precisely as possible.

If positioning the vehicle 5 as precisely as possible is not possible or not desirable, the vehicle 5 may also optionally be positioned arbitrarily, at least within a predefined tolerance range. For example, for this purpose, an area may be predefined within which a user must park the vehicle 5 via suitable aids, for example, lines on the ground. Subsequently, the exact position of the vehicle 5 may be ascertained by the charging station 1 by means of a suitable sensor system. For example, the position of the vehicle 5 may be ascertained by means of an optical sensor, for example, the optical sensor 12 of the communication device 10. However, other sensors, such as radar sensors, ultrasound sensors, optical scanners such as LiDAR, or the like, are possible for determining the position of the vehicle 5. If the position of the vehicle 5 is known, the exact position of the charging socket 51 with respect to the charging station 1 may subsequently also be determined by using the known position of the charging socket 51 with respect to the vehicle 5. For example, the determination of the charging socket 51 with respect to the charging station 1 may be determined as coordinates of a Cartesian coordinate system having an x-y-z direction. Alternative coordinate systems are also possible.

If the position of the charging socket 51 is known, a position for the charging robot 20 may be determined by the charging station 1, to which the robot 20 is to travel in order to subsequently establish an automatic connection of the charging station 1 to the charging socket 51 of the vehicle 5 to be charged. The charging position is preferably situated on the ground, i.e., on the same level on which the vehicle 5 to be charged is parked. This position to which the charging robot 20 is to travel will be referred to below as the charging position. The charging position may, for example, be determined in the communication device 10 or in the charging robot 20 or another device of the charging station 1.

The charging robot 20 of the charging station 1 includes a contact head 21. The contact head 21 includes a plurality of electrical contacts. These electrical contacts of the contact head 21 may be connected to a voltage source 30 of the charging station. In addition, one or multiple additional contacts may be connected to a reference potential of the charging station 1. Furthermore, one or multiple contacts of the contact head 21 may be connected to signal lines of the charging station 1. After establishing a galvanic connection of the contact head 21 to the charging socket 51 of the vehicle 5, data exchange between the vehicle 5 and the charging station 1 is also possible by means of such signal lines. The embodiment of the contact head 21 may, for example, correspond to a known, standardized plug for the conductive charging of an electric or hybrid vehicle. For example, a plug in accordance with European Standard EN 62196 Type 2 (or IEC Type 2) is possible. However, other standardized or novel plug types are possible for the embodiment of the contact head 21. In particular, advantageous specific embodiments for the contact head 21 of the charging robot 20 are described in greater detail below.

The contacts of the contact head 21 are electrically connected via a cable connection 31, for example, to a voltage source 30 of the charging station 1. The cable connection 31 may, for example, be a flexible electrical cable having multiple electrically conductive wires. A galvanic connection between the voltage source 30 and the contacts of the contact head 21 is thus possible via the single wires. In addition, the cable connection 31 may include other wires via which a data exchange between the vehicle 5 and the charging station 1 is made possible. The voltage source 30 may convert the voltage provided by an electrical power grid 2 or another energy source into a voltage which is suitable for charging the electrical energy storage means 50 of the vehicle 5 to be charged. For this purpose, the voltage source 30 may, for example, adjust the voltage level, convert a single- or multiphase AC voltage into a DC voltage, convert a DC voltage into a single- or multiphase AC voltage, adjust the frequency of an AC voltage, limit the amperage for charging the energy storage means 50 in the vehicle 5, etc. Alternatively, it is also possible that the contacts of the contact head 21 are directly connected to an external electrical power grid 2 or another voltage source, without a conversion of this external voltage being carried out in the charging station 1. In this case, the control for charging the energy storage means 50 of the vehicle 5 is carried out via an internal charge controller in the vehicle 5, which is not depicted.

The contact head 21 of the charging robot 20 may, for example, be connected to the charging robot 20 via a charging arm 22. The charging arm 22 may in particular be moved via a suitable drive system. For example, the charging arm 22 may be rotatably and/or pivotably arranged on the charging robot 20. By rotating and/or pivoting the charging arm 22, the contact head 21 may be oriented with respect to the charging socket 51 of the vehicle 5 to be charged. Thus, the contact head 21 may be oriented in such a way that the position of the contacts of the contact head 21 coincides with contacts of the charging socket 51. For introducing the contact head 21 into the charging socket 51 of the vehicle 5, the charging robot 20 may move in the direction of the charging socket 51. However, it is alternatively also possible that the charging arm 22 of the charging robot 20 is extensible, i.e., its length is variable. In this way, by extending the charging arm 22, i.e., by increasing the length of the charging arm 22, the contact head 21 may be moved in the direction of the charging socket 51 of the vehicle 5 until the contact head 21 is completely inserted into the charging socket 51 of the vehicle 5, and the contacts of the contact head 21 are electrically connected to contacts of the charging socket 51.

In addition, the charging robot 20 may also include a rotating device 23. By means of this rotating device 23, the contact head 21 may be rotated about a predefined axis of rotation. The axis of rotation may, for example, run in parallel with a direction in which the contact head 21 moves during insertion into the charging socket 51. The rotating device 23 may be arranged directly on the contact head 21, between the contact head 21 and the charging arm 22, within the charging arm 22, or between the charging arm 22 and a base of the charging robot 20. By rotating the contact head 21 by means of the rotating device 23, the contacts of the contact head 21 may be oriented with respect to the contacts of the charging socket 51 of the vehicle 5. The rotation of the contact head 21 via the rotating device 23 may, for example, be set based on predefined parameters which result from the vehicle-specific data of the vehicle 5 to be charged. Alternatively, a sensor system (not depicted here) on the contact head 21 or another area of the charging robot 20 may ascertain the orientation of the contacts of the charging socket 51 on the vehicle 5. Subsequently, the contact head 21 may be oriented corresponding to the orientation of the contacts on the charging socket 51. Likewise, the rotation or pivoting of the charging arm 22, as well as the extension of the charging arm 22, may be determined based on predefined parameters which result from the vehicle-specific data. Alternatively, these settings may be calculated based on sensor data which are collected by sensors of the charging robot.

The charging robot 20 may include a self-contained drive for moving the charging robot 20. For example, this drive may be an electric drive. The power for this electric drive may also be supplied via the cable connection 31. Furthermore, additional control signals for controlling the charging robot 20 may be provided to the charging robot 20 via additional wires of the cable connection 31. For controlling the direction of movement of the charging robot 20, the charging robot 20 may, for example, include steerable wheels. In addition, other options for controlling the direction of movement of the charging robot 20 are also possible. For example, the charging robot 20 may also have multiple individually driven wheels or rollers, which enable control of the direction of movement via individual activation. If the charging robot 20 does not have a separate drive, it is also possible for the charging robot 20 to be moved by means of an external drive device (not depicted here). For example, the charging robot 20 may be pushed or pulled by means of a cable or rod system. In addition, other options for the locomotion of the charging robot are also possible.

Furthermore, the charging robot 20 may have one or multiple surroundings sensors 25. For example, these surroundings sensors 25 may be a camera, an ultrasonic sensor, a laser detector such as a LiDAR, a radar sensor, and/or a contact sensor. In this way, an object in the surroundings of the charging robot 20 may be detected by means of the surroundings sensor 25. For this purpose, the charging robot 20 may, for example, detect an obstacle. Thus, a collision with a detected obstacle may be avoided. In this case, the charging robot may travel on an alternative path to the desired charging position, wherein the detected obstacle is bypassed. Furthermore, the surroundings sensors 25 may also be used to determine the orientation of the vehicle 5 to be charged and/or to determine the exact position of the charging socket 51 on the vehicle 5 to be charged.

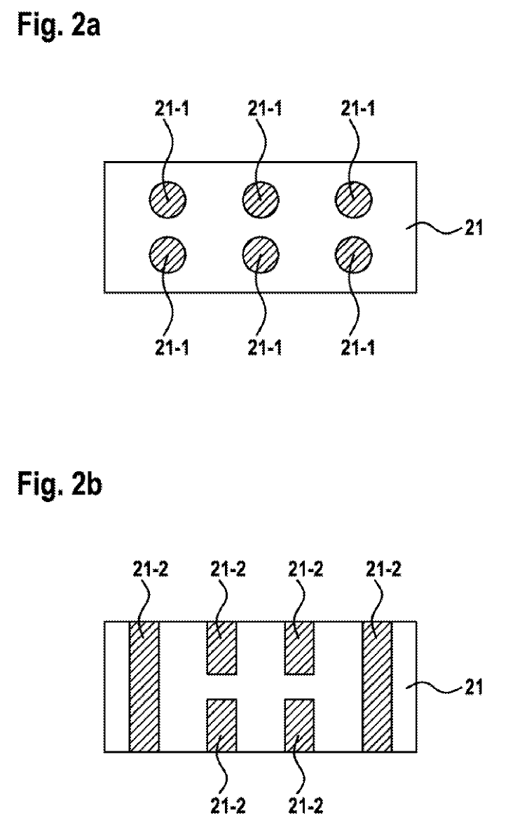

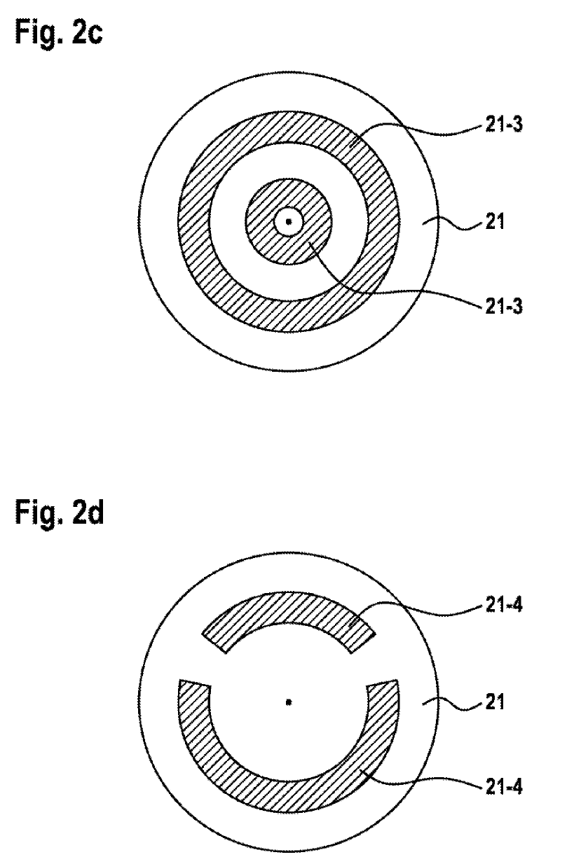

FIGS. 2a to 2d respectively show, by way of example, a top view onto a contact head 21 of a charging robot 20 for a charging station 1. In FIG. 2a, the contact head 21 includes a plurality of funnel-shaped recesses 21-1. One electrical contact of the contact head 21 may be arranged in each of these funnel-shaped recesses 21-1. Generally, recesses without electrical contacts are also possible. Such recesses may be used to improve guidance during insertion of the contact head 21 into the charging socket 51. By means of the funnel-shaped embodiment, in which the diameter of the recess continuously decreases in the direction of the interior of the contact head 21, the plug may still be inserted reliably into the charging socket 51, even in case of minor deviations in the positioning of the contact head 21 with respect to a charging socket 51 of a vehicle 5 to be charged, and an electrical connection of the contacts of the contact head 21 may be established to contacts of the charging socket 51. In this case, the funnel-shaped embodiment of the recesses allows an independent orientation of the contact head 21 with respect to the charging socket 51.

FIG. 2b shows another top view onto one embodiment of a contact head 21 of a charging robot 20 for a charging station 1. In this case, the contact head 21 has a plurality of groove-shaped recesses 21-2. The groove-shaped recesses 21-2 may have a V-shape. The width of the grooves 21-2 decreases viewed in the direction of the interior of the contact head 21. In this way as well, it is possible for the contact head 21 to be oriented independently within predefined tolerances during insertion into a charging socket 51 of a vehicle 5 to be charged. The groove-shaped recesses 21-2 may extend completely along one direction on the surface of the contact head 21. Alternatively, as depicted in the center of the contact head 21 in FIG. 2b, the grooves 21-2 may also extend over only a portion, so that multiple grooves are formed along one direction on the surface of the contact head 21. One electrical contact may be arranged in the interior of each of the grooves 21-2. Recesses without electrical contacts are also possible in this embodiment and the following embodiments.

FIGS. 2c and 2d show circular contact heads 21. In FIG. 2c, the contact head 21 has circular recesses 21-3, in which one electrical contact may be arranged in each case. By means of such rotationally symmetrical contact heads 21, insertion of the contact head 21 into a charging socket 51 of a vehicle 5 may be particularly simple. In this case, no rotation of the contact head 21 has to take place for orienting the contacts.

FIG. 2d shows a circular contact head 21 in which, however, the recesses 21-4 are designed in the contact head 21 as circle segments. In this way, multiple contacts may be arranged within one circle circumference. Thus, a larger number of contacts may be achieved in a smaller space. In order to force an unambiguous orientation in the case of a circular contact head 21 as depicted, for example in FIG. 2d, the individual circle sectors may be designed having different sizes. In this case, both the width of the recesses 21-4 and the size of the circle segment may vary. In this way, it may be ensured that a circular contact head 21 may also be inserted in only one predetermined orientation into the charging socket 51 of a vehicle 5.

The number of recesses and contacts depicted with respect to FIGS. 2a to 2d serves merely to improve understanding, and does not constitute a limitation of the present invention. A number of contacts differing from the depicted number of contacts is also possible. The rectangular contact heads depicted in FIGS. 2a and 2b are also to be understood to be exemplary. Geometries differing from this, for example, square shapes, polygons, etc., are also possible.

Preferably, the contact heads 21 have a conical or tapered or frustoconical exterior geometry. The base area on which the contacts or the recesses for the contacts are arranged has a smaller base area in comparison to the side pointing in the direction of the charging arm 22. In other words, the contact head 21 tapers in the direction of the area on which the contacts or the recesses for the contacts are arranged. Thus, an independent orientation of the contact head 21 within predefined tolerances is possible during insertion into the charging socket 50.

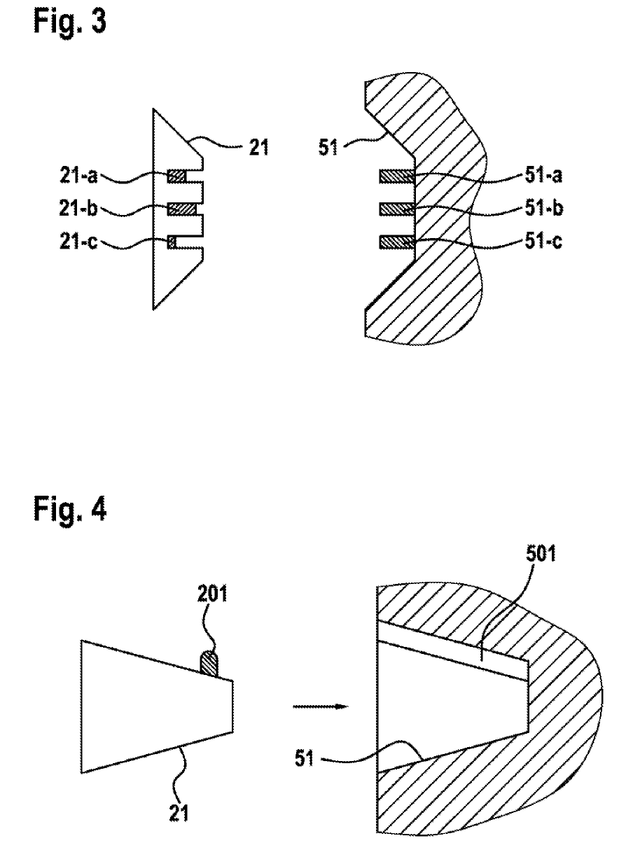

FIG. 3 shows a schematic representation of a cross section through a contact head 21 of a charging robot 20 and a corresponding charging socket 51 of a vehicle 5. For connecting the contact head 21 to the charging socket 51, the contact head 21 is inserted to the right in FIG. 3, in the direction of the charging socket 51. In this example, the charging socket 51 has three contacts 51-a, 51-b, and 51-c. The contact head 21 correspondingly has three recesses having the contacts 21-a, 21-b, and 21-c. While in this example, the three contacts 51-a, 51-b, and 51-c of the charging socket 51 are designed having equal length, the contacts 21-a, 21-b, and 21-c of the contact head 21 within the contact head 21 are spaced at different distances from the external side, pointing in the direction of the charging socket 51. In this way, it may be achieved that when inserting the contact head 21 into the charging socket 51, the contacts 21-a, 21-b, and 21-c of the contact head 21 are electrically connected to the corresponding contacts 51-a, 51-b, and 51-c of the charging socket 51 at different instants. Thus, for example, it may be ensured that an electrical connection of a reference potential is established initially. Only after the reference potential of the contact head 21 has been connected, via the corresponding contact, to the charging socket and thus to the vehicle to be charged, the connection of the phase terminals subsequently takes place during further insertion of the contact head 21 into the charging socket 51, via which the energy is to be supplied during the charging of the energy storage means 50 in the vehicle 5. Finally, after these contacts have been electrically interconnected, a data link which is required for communication during charging may be established, via which the charging process is enabled. In this way, safety may be increased during the connection, and any existing safety requirements may be met.

In addition to the exemplary embodiment depicted here, in which the contacts 51-a, 51-b, and 51-c of the charging socket 51 are of equal length, and the contacts 21-a, 21-b, and 21-c of the contact head 21 are arranged in different positions with respect to the spacing from the outside of the contact head 21 pointing in the direction of the charging socket 51, it is alternatively also possible to arrange a charging socket 51 having contacts 51-a, 51-b, and 51-c of different lengths in the vehicle and to arrange the contacts 21-a, 21-b and 21-c of the contact head 21 spaced equidistantly from the outside, pointing in the direction of the charging socket 51.

FIG. 4 shows a schematic representation of a cross section through a charging socket 51 and a contact head 21 of a charging robot 20 for a charging station, according to another embodiment. The contact head 21 has a guiding device 201. This guiding device 201 may, for example, be a roller, a ball wheel, a peg, or another protrusion. Furthermore, a recess, for example, a groove or the like, is also possible as a guiding device 201. A guide corresponding to the guiding device 201 of the contact head 21 is incorporated on the charging socket 51 of the vehicle 50. Thus, when inserting the contact head 21 into the charging socket 51, the contact head 21 may be oriented with respect to the charging socket 51 due to the interaction of the guiding device 201 with the corresponding element 501 in the charging socket 51. In particular, it is possible the contacts of the contact head 21 are oriented in such a way that they are properly connected to the contacts of the charging socket 51. In addition, to improve the anti-friction properties when inserting the contact head 21 into the charging socket 51, the surface of the contact head 21 and/or the surface of the charging socket 51 may be coated with a low-friction material. For example, a coating made of polytetrafluorethylene (PTFE) or the like is suitable for this purpose.

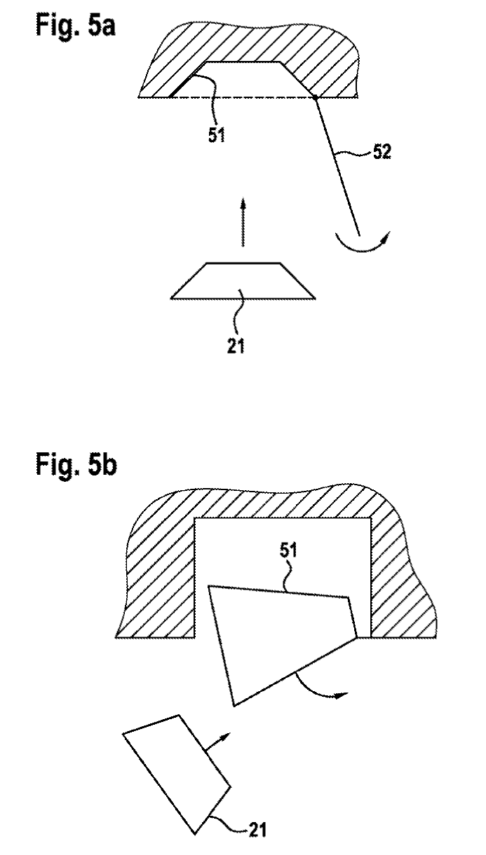

FIGS. 5a and 5b show schematic representations of the insertion of a contact head 21 into a charging socket of a vehicle 5. In FIG. 5a, the charging socket 51 is sealed by a cover 52 (shown by dashed lines) in the non-operating state. This cover 52 must therefore be opened in order to unblock the charging socket 51, so that the contact head 21 may be inserted into the charging socket 51. For this purpose, for example, the contact head 21 may push the cover 52 aside during insertion of the contact head 21 into the charging socket 51. Alternatively, the charging robot 20 may also have an additional device which is suitable for removing the cover 52 in front of the charging socket 51. For example, the cover 52 may be folded out, as shown in FIG. 5a. This may, for example, be carried out via a mechanical device which is triggered by the charging robot 20. Alternatively, the charging robot 20 or another device of the charging station 1 may communicate with the vehicle 5 in order to induce the vehicle 5 to open the cover 52 in front of the charging socket 51.

FIG. 5b shows another embodiment in which the charging socket 51 is initially protected in the non-operating state and is unblocked only for inserting the contact head 21. In this case, the charging socket 51 is initially directed into the vehicle interior in the non-operating state. For charging the energy storage means 50 of the vehicle 5, the charging socket 51 is folded out in the direction of the arrow. For this purpose, the charging robot 20 or another device of the charging station 1 may induce the vehicle 5 to fold out the charging socket 51. The charging socket 51 may be folded out, for example, by means of a mechanical device which is triggered by the charging robot 20. Alternatively, the vehicle 5 may also be induced to fold out the charging socket 51 by means of a motor-driven device.

After the charging socket 51 has been folded out and/or a cover 52 in front of the charging socket 51 has been opened, the charging robot 20 may insert the contact head 21 into the charging socket 51 and thus electrically connect the contacts of the charging socket 21 to contacts of the charging socket 51.

For galvanically connecting the charging station 1 to the vehicle 5, the charging robot 20 inserts the contact head 21 into the charging socket 51 of the vehicle. For this purpose, the charging robot 20 initially travels to a charging position ascertained as described above. Preferably, this charging position is located on the ground. If the charging socket 51 is initially protected as described with respect to FIGS. 5a and 5b, the charging socket 51 is subsequently initially unblocked. The contact head 21 is then inserted into the charging socket 51. For this purpose, the contact head 21 is optionally initially oriented with respect to the charging socket 51 by the charging robot, by means of suitable tilting and rotating devices. Deviations in the orientation of the contact head 21 with respect to the charging socket 51 may be corrected during insertion of the contact head 21 into the charging socket 51 via the previously described actions such as funnel-shaped recesses in the contact head 21, V-shaped grooves in the contact head 21, a design of the contact head 21 having a conical or frustoconical exterior geometry, and optionally via a guiding device 201. In this case, during insertion of the contact head 21 into the charging socket 51, it may occur that the contact head 21 must be moved laterally, i.e., perpendicularly to the direction of insertion. In order for the contact head 21 to be able to carry out such a lateral movement, a compensating element 24 may be attached to the charging arm 22. Such a compensating element 24 also makes it possible for the contact head 21 to be able to carry out a movement during insertion of the contact head 21 into the charging socket 51 which is perpendicular, or at least approximately perpendicular, with respect to the direction of movement of the contact head 21 with which the charging robot 20 inserts the contact head 21 into the charging socket 51. For example, this compensating element 24 may be a spring element, a link having a predetermined restoring force, a section made of an elastomer, or the like. If a force below a predefined threshold value is exerted on the compensating element, the compensating element 24 remains at least approximately rigid. However, if the exerted force exceeds the predefined threshold value, the compensating element 24 gives way and thus allows a deviation, in particular a lateral deviation, of the contact head 21 during insertion of the contact head 21 into the charging socket 51.

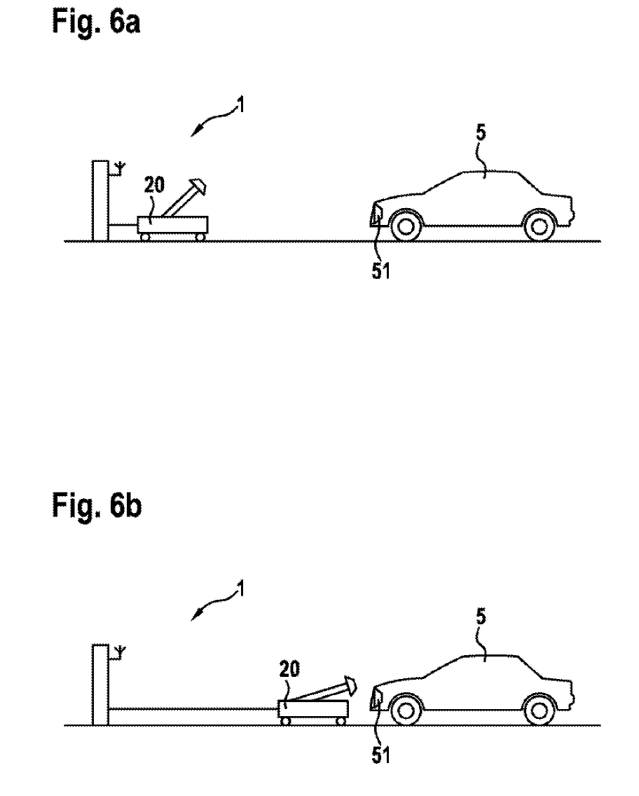

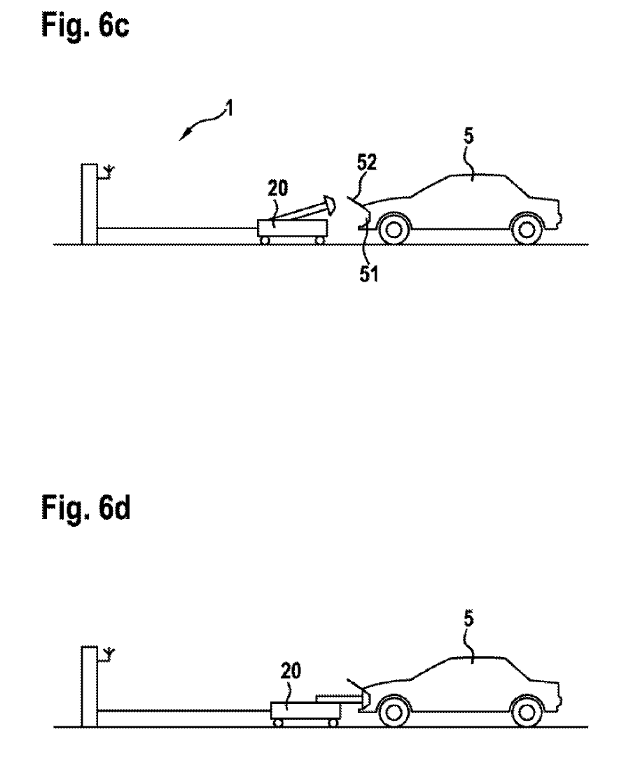

FIGS. 6a to 6d schematically depict the sequence for automatically charging an energy storage means 50 in a vehicle 5, according to one embodiment. As depicted, for example, in FIG. 6a, for this purpose, a vehicle 5 is initially parked at the charging station 1 within a predefined parking area. Subsequently, the communication device 10 of the charging station 1 receives vehicle-specific data. The vehicle-specific data may, for example, be the vehicle-specific data already executed. From this vehicle-specific data, the charging station 1 subsequently initially ascertains the position of a charging socket 51 on the vehicle 5. From this position of the charging socket 51 on the vehicle 5, a charging position for the charging robot 20 may subsequently be ascertained, optionally using the exact positioning of the vehicle 5 with respect to the charging station 1. This charging position constitutes a position for the charging robot 20, from which the charging robot 20 may insert the contact head 21 independently into the charging socket 51 of the vehicle 50. Preferably, the charging position is situated on the same base surface, i.e., on the ground on which the vehicle 5 is parked.

After a suitable charging position for the charging robot 20 has been ascertained, the charging robot 20 travels to this charging position, as shown in FIG. 6b. In this case, if the charging robot 20 has self-contained drive, the charging robot 20 may head for the charging position under its own power. By means of optionally available surroundings sensors 25, the charging robot 20 may detect objects in the surroundings of the charging robot 20 and bypass them when heading for the charging position.

After the charging robot 20 has reached the charging position, an optionally covered charging socket 51 on the vehicle 5 may be unblocked. As shown in FIG. 6c, for this purpose, the charging robot 20 may trigger a mechanism on the vehicle 5 in order to fold aside a cover 52 which is possibly present in front of the charging socket 51. Alternatively, the charging robot 20 may also trigger a mechanism which folds out an initially inwardly folded charging socket 51, and thus makes it accessible to the charging robot 20.

After the charging socket 51 has been unblocked, the charging robot 20 inserts the contact head 21 into the charging socket 51 of the vehicle 5. The contacts of the contact head 21 are thereby electrically connected to contacts of the charging socket 51. The charging of the electrical energy storage means 50 in the vehicle 5 may then begin. For this purpose, a voltage may be provided, for example, by the voltage source 30 of the charging station 1, which is suitable for charging the energy storage means 50, based on the previously received vehicle-specific data. In this case, in particular a voltage level, the voltage waveform, and optionally other parameters such as amperage, etc., may be adjusted and matched to the respective electrical energy storage means 50 of the vehicle 5.

After completing the charging process, the charging robot 20 may unplug the contact head 21 from the charging socket 51. Subsequently, the charging socket 51 may be closed by a cover 52 or folded back into the vehicle interior. After that, the charging robot 20 may travel back to a parking position. Alternatively, after completing the charging process on a vehicle 5, the charging robot 20 may also immediately head for another charging position, in order subsequently to charge an electrical energy storage means of another vehicle.

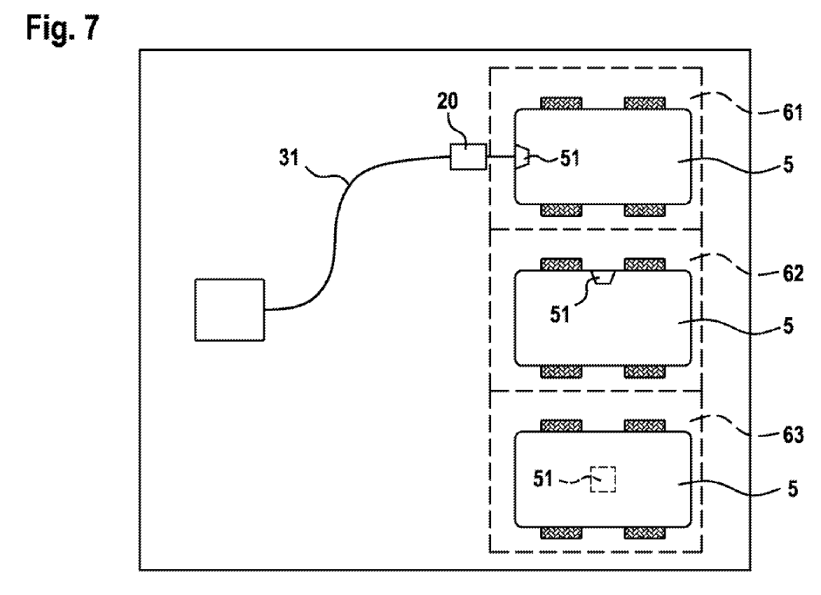

FIG. 7 shows a schematic representation of a charging station 1 for automatically charging a plurality of vehicles 5 having electrical energy storage means 50. In this case, the charging station 1 includes multiple parking spaces 61 to 63, at which a vehicle 5 may be parked in each case. The charging station 1 receives the vehicle-specific data about the vehicles parked in the parking spaces 61 to 63, for example, by means of one or multiple communication devices 10. Subsequently, the charging robot 20 of the charging station 1 may head for a charging position for each of the vehicles 5 sequentially, insert the contact head 21 into the charging socket 51 of the corresponding vehicle 5, and charge the electrical energy storage means 50 of the respective vehicle 5. After the charging process has been concluded for an energy storage means 50, the charging robot 20 may subsequently unplug the contact head 21 from the corresponding charging socket 51, head for another charging position of another vehicle 5 at one of the parking spaces 61 to 63, and subsequently charge the electrical energy storage means 50 of the next vehicle 5. The sequence in which the charging robot 20 heads for the individual vehicles and charges the respective energy storage means 50 of the vehicles 5 may be chosen based on any arbitrary specifications. For example, a priority, a desired target time at which the charging process is to be concluded, or the like, may be specified in the received vehicle-specific data.

In addition, it is also possible to charge an electrical energy storage means 50 of a particular vehicle 5 for a predefined time period, to subsequently interrupt the charging process, and to charge another energy storage means 50 of another vehicle 5 for a predefined time period. Thus, the energy storage means of multiple vehicles may be charged in an alternating manner. In addition, other schemes for charging the electrical energy storage means 50 of multiple vehicles 5 are also possible.

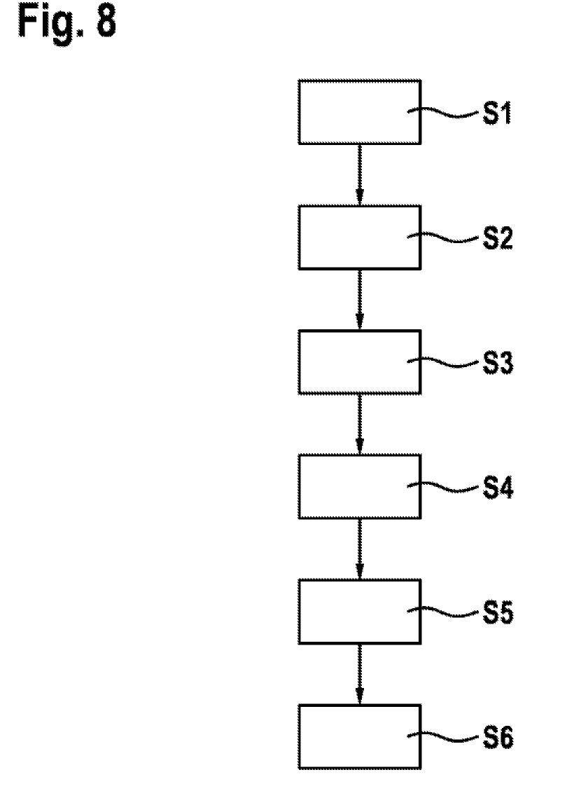

FIG. 8 shows a schematic representation of a flow chart for a method for automatically charging an electrical energy storage means 50 in a vehicle 5. In step S1, a charging robot 20 is initially provided. As previously described, the charging robot 20 includes at least one contact head 21 having a plurality of contacts. The contacts of the contact head 21 are connected to a voltage source. For example, this voltage source may be the voltage from an external power grid. Alternatively, the voltage source may also be an internal voltage source 30, in particular a charge controller 30, which controls the charging process for charging an electrical energy storage means 50 of a vehicle 5. The charge controller may set the voltage level, the voltage type, and the amperage during the charging, as well as other parameters.

In step S2, vehicle-specific data are received from the vehicle 5. For this purpose, for example, a communication device 10 may carry out a data exchange with the vehicle 5 by means of a wireless interface. Alternatively, a barcode, a QR code, or another piece of information, for example, optical information, may also be read out from the vehicle, in order thereby to obtain vehicle-specific data. In particular, the license number of the vehicle may be detected, and the vehicle-specific data may thereby be derived. In step S3, a position of the charging socket 51 on the vehicle 5 is ascertained using the received vehicle-specific data. Access to an internal or external database is possible for ascertaining this position of the charging socket 51 on the vehicle 5. For example, the position of the charging socket, and optionally other data relevant to charging, may be stored in an internal or external database for each vehicle, or for predefined vehicle types. Based on the received vehicle-specific data, all data and charging parameters relevant to charging may be ascertained from such an internal or external database.

In step S4, a charging position is determined based on the ascertained position of the charging socket 51 on the vehicle 5. This charging position is a position from which a charging robot 20 may insert its contact head 21 into the charging socket 51 of the vehicle. This charging position is preferably situated on the ground and near the charging socket 51 of the vehicle 5. Subsequently, the charging robot 20 travels to the charging position. If the charging robot 20 has a self-contained drive, the charging robot 20 may independently travel to the charging position. Alternatively, the charging robot 20 may also be moved, in particular pushed or pulled, via a separate device, in order to travel to the charging position. If the charging robot 20 has surroundings sensors 25, the charging robot 20 may also detect objects in the surroundings of the charging robot 20, and bypass these detected objects when traveling to the charging position 20. Thus, a collision by the charging robot 20 with the detected objects may be avoided.

After the charging robot 20 has reached the charging position, in step S6, the charging robot 20 may insert the contact head 21 into the charging socket 51 of the vehicle 5, and establish an electrical connection of the contacts of the contact head 21 to contacts of the charging socket 51.

If the contact head 21 is completely inserted into the charging socket 51 of the vehicle 5, a verification of the successful connection may optionally be carried out. For this purpose, for example, an electrical connection of a specific contact may be checked. In this case, this contact may be designed in such a way that the electrical connection of this contact is carried out last. Thus, it may be ensured that all other contacts have already been previously connected correctly.

If the contact head 21 is completely inserted into the charging socket 50, the charging station 1 may provide electrical energy to the contacts of the contact head 21. As a result, the electrical energy storage means 50 of the vehicle 5 may be charged.

If the electrical energy storage means 50 of the vehicle 5 has reached the desired charge state, or if other setpoint values have been reached, the charging process of the electrical energy storage means 50 may be terminated. To do this, the voltage provided to the contacts of the contact head 21 is disconnected by the charging station 1. The contact head 21 may then be unplugged from the charging socket 51. After that, the charging robot 20 may leave its charging position. The charging robot 20 may, for example, head for a parking position, or travel to another charging position at an adjacently parked vehicle.

In summary, the present invention relates to a device and a method for automatically charging an electrical energy storage means in a vehicle. For this purpose, the position of a charging socket on a vehicle is initially ascertained based on vehicle-specific data. Subsequently, a charging robot travels on the ground into the vicinity of the charging socket. After that, the charging robot establishes a galvanic connection between the charging station and the charging socket. For this purpose, the charging robot inserts a contact head connected to the charging station into the charging socket of the vehicle. After completion of the charging process, the contact head is unplugged from the charging socket, and the vehicle is thus released.

1. A charging station (1) for automatically charging an electrical energy storage means (50) in a vehicle (5), the charging station comprising:
a communication device (10) configured to receive vehicle-specific data from the vehicle (5) and to ascertain a position of a charging socket (51) on the vehicle (5) using received vehicle-specific data; and
a charging robot (20) which includes a contact head (21) having a plurality of contacts, wherein the contacts are connected to a voltage source (30);
wherein the charging robot (20) is configured to travel to a charging position based on an ascertained position of the charging socket (51) on the vehicle (5), and after reaching the charging position, to insert the contact head (21) into the charging socket (51) of the vehicle (5) and to electrically connect the contacts of the contact head (21) to contacts of the charging socket (51).

2. The charging station (1) as claimed in claim 1, wherein the contact head (21) of the charging robot (20) includes funnel-shaped or groove-shaped recesses (21-1, 21-2), in which the contacts of the contact head (21) are arranged.

3. The charging station (1) as claimed in claim 1, wherein the contact head (21) includes a guiding device (201) which is configured to adjust a position of the contact head (21) during insertion into the charging socket (51).

4. The charging station (1) as claimed in claim 3, wherein the guiding device (201) comprises a roller, a ball wheel, a peg, a groove, and/or a slide rail.

5. The charging station (1) as claimed in claim 1, wherein the contact head (21) has a conical exterior geometry which tapers in a direction of the contacts.

6. The charging station (1) as claimed in claim 1, wherein the charging robot (20) includes a rotating device (23) which is configured to rotate the contact head (21) about a predetermined axis of rotation.

7. The charging station (1) as claimed in claim 1, wherein the charging robot (20) includes an extensible charging arm (22), and the contact head (21) is arranged on the extensible charging arm (22).

8. The charging station (1) as claimed in claim 7, wherein the charging arm (22) includes a flexible compensating element (24).

9. The charging station (1) as claimed in claim 1, wherein the charging robot (20) includes a surroundings sensor (25) configured to detect an object in surroundings of the charging robot (20).

10. The charging station (1) as claimed in claim 9, wherein the surroundings sensor (25) includes a camera, an ultrasonic sensor, a laser detector (LiDAR), a radar sensor, and/or a contact sensor.

11. The charging station (1) as claimed in claim 1, wherein the communication device comprises a radio interface, an infrared interface, a camera, a barcode scanner, and/or a QR code scanner,

12. A method for automatically charging an electrical energy storage means (50) in a vehicle (5), the method comprising the steps of:
providing (S1) a charging robot (20) which includes a contact head (21) having a plurality of contacts, wherein the contacts are connected to a voltage source (30);
receiving (S2) vehicle-specific data from the vehicle (5);
ascertaining (S3) a position of a charging socket (51) on the vehicle (5) using received vehicle-specific data;
determining (S4) a charging position based on an ascertained position of the charging socket (51) on the vehicle (5);
traveling (S5) to the charging position by means of the charging robot (20); and
inserting (S6) the contact head (21) of the charging robot (20) into the charging socket (51) of the vehicle (5), and electrically connecting the contacts of the contact head (21) to contacts of the charging socket (51) after the charging robot (20) has reached the charging position.

13. The method as claimed in claim 12, wherein the step for ascertaining (S3) the position of the charging socket (51) on the vehicle (5) reads out the position of the charging socket (51) using the received vehicle-specific data from an internal or external database (15, 3).

14. The method as claimed in claim 12, further comprising a step for ascertaining charging parameters for charging the electrical energy storage means (50) in the vehicle (5), based on the received vehicle-specific data.

15. The method as claimed in claim 14, wherein the charging parameters include information about the charging voltage, charging current, amount of energy to be transmitted, start time for charging, end time for charging, time period for charging, and/or billing data.
